(19) United States
(12) Patent Application Publication
(10) Pub. No.: US 2013/0288766 A1
(43) Pub. Date: Oct. 31, 2013

(54) GAME DEVICE, GAME SYSTEM, CONTROL METHOD, AND PROGRAM

(71) Applicant: KONAMI DIGITAL ENTERTAINMENT CO., LTD., Tokyo (JP)

(72) Inventors: Akitsu TERASHIMA, Minato-ku (JP); Kazuhiro KUSUDA, Hiratsuka-shi (JP)

(73) Assignee: KONAMI DIGITAL ENTERTAINMENT CO., LTD., Tokyo (JP)

(21) Appl. No.: 13/708,099

(22) Filed: Dec. 7, 2012

(30) Foreign Application Priority Data
Apr. 27, 2012 (JP) 2012-103744
Jun. 13, 2012 (JP) 2012-133820

(51) Int. Cl. A63F 13/00; A63F 13/12

(52) U.S. Cl. CPC A63F 13/005; A63F 13/12
USPC 463/16

(57) ABSTRACT

A game system includes a setting unit allocating each item of a plurality of game items with its own item-selecting probability. The system also includes a selection unit configured to perform an item-selection process in accordance with the item-selecting probabilities that are selectively allocated to the plurality of game items. The system also includes a game item granting unit that grants each item to player in accordance with a result of at least one of the item-selection processes performed by the selection unit. The system also includes an advantage granting unit that grants at least an advantage to game player, if the item granting unit has granted, to player, at least one predetermined item included in the plurality of items. The system also includes a setting unit that re-allocates a higher item-selecting probability to at least one game item, if the setting unit recognizes that a predetermined condition is satisfied.

### BACKGROUND OF THE INVENTION

1. Field of the Invention

The present invention relates to a game device, a game system, a control method, and a program.

Priories are claimed on Japanese Patent Applications Nos. 2012-103744, filed Apr. 27, 2012, and 2012-133820, filed Jun. 13, 2012, the contents of which are incorporated herein by reference.

2. Description of the Related Art

There are games in which a game player is given some game items such as cards, game characters, or the like, so that the game player can use these game items to progress through the game. Japanese Laid-open Patent Publication No. 2011-206449 discloses an example of such a game system.

In a game such as described above, a player, by getting a predetermined game item, can use the game item to an advantage in progressing through the game. If, however, the player cannot get a predetermined game item, the player cannot progress through the game with some advantage. For this reason, although the player actively plays the game to try to get a predetermined game item, as the period of time during which the player cannot get the predetermined game items becomes long, the game could become gradually unenjoyable, and the player could become unaggressive with respect to playing.

One method of giving a game item to a player has been known for giving a game item using an item-selection process or selection. If this method is used, the game item is selected with a predetermined item-selecting probability.

### SUMMARY

In one embodiment, a game system may include, but is not limited to, a setting unit, a selection unit, a game item granting unit, an advantage granting unit, and an advantage granting unit. The setting unit is configured to allocate each game item of a plurality of game items with its own item-selecting probability. The selection unit is configured to perform an item selection process in accordance with the item-selecting probabilities that are respectively allocated to the plurality of game items. The game item granting unit is configured to grant at least one of the plurality of game items to game player in accordance with a result of at least one of the item-selection processes performed by the selection unit. The advantage granting unit is configured to grant at least an advantage to game player, if the game item granting unit has granted, to game player, at least one predetermined game item that is included in the plurality of game items. The setting unit is configured to re-allocate a higher item-selecting probability to at least one game item that has been allocated with a lower item-selecting probability than the higher item-selecting probability, if the setting unit recognizes that a predetermined condition is satisfied.

In some cases, the setting unit may be configured to re-allocate the higher item-selecting probability to at least one game item of the non-highest item-selecting probability once allocated and lower than the highest item-selecting probability, if the setting unit recognizes that the predetermined condition is satisfied.

In some cases, the predetermined condition may include, but is not limited to, a condition related to the status of progress through the game.

In some cases, the predetermined condition may include, but is not limited to, a condition related to the status of granting game player the game items having the higher item-selecting probability.

In some cases, the predetermined condition may include, but is not limited to, a condition indicating that all of the game items having the higher item-selecting probability have been granted to game player.

In some cases, the predetermined condition may include, but is not limited to, a condition related to an elapsed time elapsed after the start of a predetermined period of time.

In some cases, the predetermined condition may include, but is not limited to, a condition related to an elapsed time after the start of the selection process by the selection unit upon instructions by game player.

In some cases, the game system may further include, but is not limited to, an elapsed time detection unit configured to detect the elapsed time. The setting unit is configured to re-allocate a higher item-selecting probability to at least one game item having a lower item-selecting probability than the higher item-selecting probability, if the setting unit recognizes that the predetermined condition is satisfied by determining that the elapsed time detected by the elapsed time detection unit is equal to or greater than a predetermined threshold value.

In some cases, the setting unit may be configured to re-allocate a higher item-selecting probability to at least one game item having a lower item-selecting probability than the higher item-selecting probability, if the setting unit recognizes that the predetermined condition is satisfied by determining that the elapsed time detected by the elapsed time detection unit is equal to or greater than a predetermined threshold value. The determination is made by the setting unit with reference to a re-setting schedule. The re-setting schedule associates the predetermined threshold value to the game items to be re-allocated with the higher item-selecting probability.

In some cases, the predetermined conditions may include, but is not limited to, a condition related to the number of times that the selection unit has conducted the selection process.

In some cases, the game item granting unit is configured to associate game player with the game item that has been granted to game player, and the selection unit is configured to perform an item-selection process, in accordance with a request by game player, game items of the plurality of game items other than the game items associated with game player.

In another embodiment, a method of controlling a game system may include, but is not limited to, allocating each game item of a plurality of game items with its own item-selecting probability; performing an item-selection process in accordance with the item-selecting probabilities that are respectively allocated to the plurality of game items; granting at least one of the plurality of game items to game player in accordance with a result of at least one of the item-selection processes as performed; granting at least an advantage to game player, if game player has been granted with at least one predetermined game item that is included in the plurality of game items; and re-allocating a higher item-selecting probability to at least one game item that has been allocated with a lower item-selecting probability than the higher item-selecting probability, if a predetermined condition is satisfied.

In still another embodiment, a non-transitory computer-readable storage medium stores a program to be executed to perform a method of controlling a game system. The method may include, but is not limited to, allocating each game item of a plurality of game items with its own item-selecting probability; performing an item-selecting process in accordance with the item-selecting probabilities that are respectively allocated to the plurality of game items; granting at least one of the plurality of game items to game player in accordance with a result of at least one of the item-selection processes as performed; granting at least an advantage to game player, if game player has been granted with at least one predetermined game item that is included in the plurality of game items; and re-allocating a higher item-selecting probability to at least one game item that has been allocated with a lower item-selecting probability than the higher item-selecting probability, if a predetermined condition is satisfied.

### BRIEF DESCRIPTION OF THE DRAWINGS

The above features and advantages of the present invention will be more apparent from the following description of certain preferred embodiments taken in conjunction with the accompanying drawings.

FIG. 1 is a block diagram showing the configuration of a game system according to one embodiment of the present invention.

FIG. 2 is a drawing showing an example of an image on a screen of a game system according to one embodiment of the present invention.

FIG. 3 is a drawing showing an example of an image in game progression on the screen of the game device according to one embodiment of the present invention.

FIG. 4 is a drawing showing an example of an image in battle on the screen of the game device according to one embodiment of the present invention.

FIG. 5 is a drawing showing an example of an image in item-selection process starting on the screen of the game device according to one embodiment of the present invention.

FIG. 6 is a drawing showing an example of an image in item-selection results on the screen of the game device according to one embodiment of the present invention.

FIG. 7 is a table showing an example of player information data stored in a player information storage unit.

FIG. 8 is a table showing an example of game item information data stored in a game item information storage unit.

FIG. 9 is a flowchart showing an example of operation in item-selection process by the present embodiment.

FIG. 10 is a table showing a first example of the item-selection conditions stored in an item-selection conditions storage unit.

FIG. 11 is a flowchart showing operation in the processing for re-setting the selectable range in accordance with the item-selection conditions shown in FIG. 10.

FIG. 12 is a table showing a second example of the item-selection conditions stored in the item-selection conditions storage unit.

FIG. 13 is a flowchart showing operation in the processing for re-setting the selectable range in accordance with the item-selection conditions shown in FIG. 12.

FIG. 14 is a table showing a third example of the item-selection conditions stored in the item-selection conditions storage unit.

FIG. 15 is a table showing a fourth example of the item-selection conditions stored in the item-selection conditions storage unit.

FIG. 16 is a table showing a fifth example of the item-selection conditions stored in the item-selection conditions storage unit.

FIG. 17 is a flowchart showing an example of operation in the processing for re-setting the card that has been given to a player to be a card that is not a subject of the item-selection.

### DETAILED DESCRIPTION OF THE PREFERRED EMBODIMENTS

Embodiments of the invention will be now described herein with reference to illustrative embodiments. Those skilled in the art will recognize that many alternative embodiments can be accomplished using the teaching of the embodiments of the present invention and that the invention is not limited to the embodiments illustrated for explanatory purpose.

An embodiment of the present invention will be described below, with references made to the drawings.

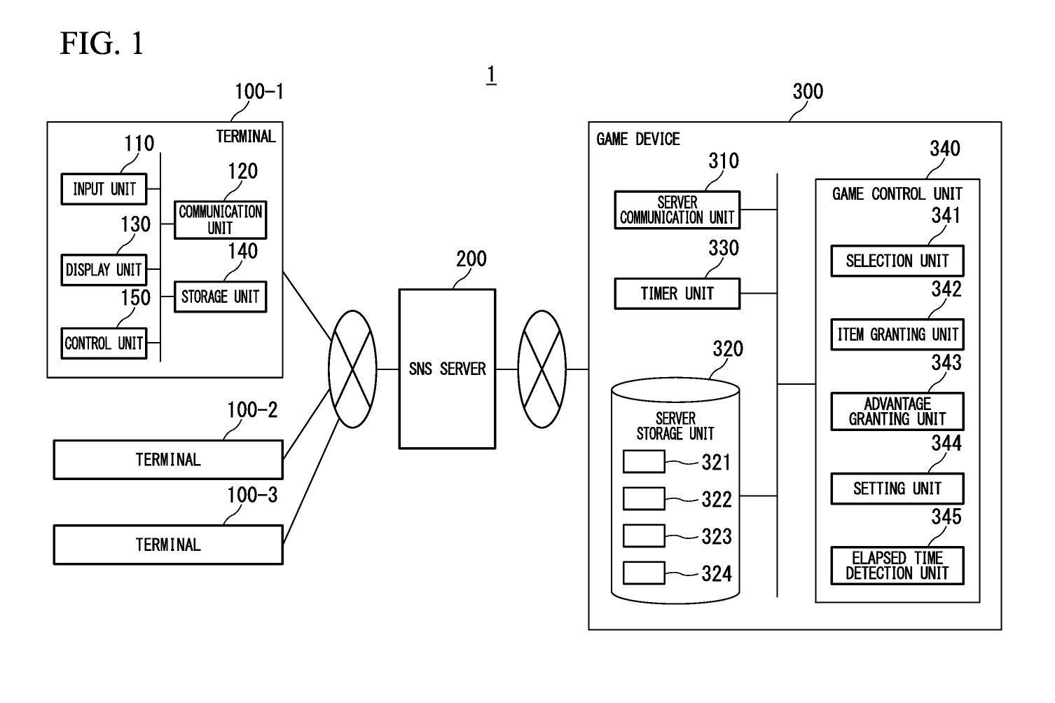

FIG. 1 is a block diagram that shows the configuration of a game system 1 according to the present embodiment. The game system 1 may include, but is not limited to, computers, which are a user terminal 100-1, a user terminal 100-2, a user terminal 100-3, . . . , an SNS server 200, and a game device 300. These computers may be acceptable to any available network for connection among them. In some cases, the user terminal 100-1, the user terminal 100-2, and the user terminal 100-3 have the same configuration, unless a particular distinction is made, the indications of −1, −2 and the like will be omitted. Thus, the description will be of a user terminal 100. Although in this case there are three user terminals 100 illustrated in the drawings, an arbitrary number of user terminals 100 may be connected to the game device 300 via the SNS server 200.

The game system 1 will first be generally described. The SNS server 200 provides an SNS (social networking service) to a plurality of users that are member thereof. The game device 300, which is a server that operates the game, provides a game to the user terminals 100 via the SNS server 200. For example, the game device 300 is configured to provide a social game that is operable on an SNS provided by the SNS server 200. A user terminal 100 is configured to allow a player to play a game provided by the game device 300. In the present embodiment, the game device 300 is configured to provide a game such that, a player progresses through the game and uses items such as cards given to the player within the game by an item-selection process to engage in a battle between the player and an opponent.

The configurations of each computer of the game system 1 will be described.

The user terminal 100 is a computer used by a player that can be, for example, a PC (personal computer), a tablet personal computer, a mobile phone such as a smart phone or feature phone, or a portable information terminal (PDA: personal digital assistant) or the like. In the present embodiment, the user terminal 100 is described as being a smart phone. The user terminal 100 includes an input unit 110, a communication unit 120, a display unit 130, a storage unit 140, and a control unit 150.

The input unit 110 includes an input device such as buttons or a touch panel, and receives input of instruction information from a player. The input unit 110 may include a microphone that receives input of instruction information from a player in the form of speech.

The communication unit 120 communicates with other computers that are connected via a network.

The display unit 130 is a display that displays information such as images and text, for example, a liquid-crystal display or an organic EL (electroluminescence) display. As described above, the input unit 110 may be a touch panel that is integrated with the display unit 130, and that receives operations by a user.

The storage unit 140 stores various types of information used when operating the user terminal 100.

The control unit 150 includes an information processing device such as a CPU (central processing unit) that functions as the control center of the user terminal 100 that controls various parts of the user terminal 100. For example, the control unit 150 performs processing in accordance with instruction information from a user input to the input unit 110, and processing for displaying on the display unit 130 of information such as a webpage that is retrievable from the SNS server 200 or the game device 300 via the communication unit 120. The control unit 150 also performs processing for display on the display unit 130 of information related to a game provided from the game device 300 via the communication unit 120, and processing for progressing through a predetermined game provided from the game device 300 by exchange of information related to the game device 300 and the game.

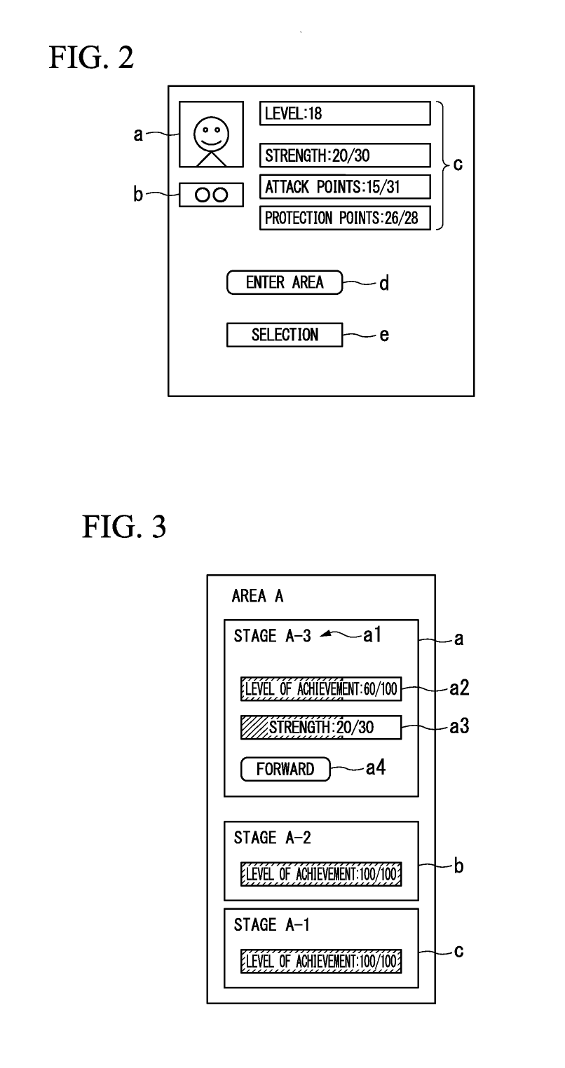

The game according to the present embodiment is a game that is provided from the game device 300, and that may be played by a browser application in the user terminal 100. The control unit 150 processes for the display unit 130 to display a game provided from the game device 300 via the network so as to enable play thereof with a browser application. Before starting the game, a player registers as a user of the game device 300, via the network, and sets various information regarding the player, such as identifying account information (user ID and password) and supplementary player information (such as the player's name, an image showing the player, and a player's e-mail address). FIG. 2 to FIG. 6 are drawings that show examples of the game screens displayed on the display unit 130 by the control unit 150.

FIG. 2 is a drawing that shows an example of the basic screen of a game displayed on the display unit 130 when a game is started. The control unit 150 displays an image showing the player of the game in the region of the symbol a in the basic game screen. This image may be, for example, an image showing the player that is set at the time of the user registration described above (for example, a photograph image, an avatar image of the player him/herself, or a character image). The control unit 150 processes for the display unit 130 to display the player name in the region of the symbol b, and display various attribute values of the player within the game in the region of the symbol c. The control unit 150 processes for the display unit 130 to display, in the region of the symbol d, an Enter Area button that accepts input of an instruction to start progressing through the game from an area set by the player within the game and displays, in the region of the symbol e, a selection button that accepts input of an instruction to perform an item-selection process for the purpose of selecting and giving a player a game item (for example, a card) to use within the game.

FIG. 3 is a drawing that shows an example of the progression screen of a game displayed on the display unit 130 when the Enter Area button is pressed. In this case, a plurality of stages is associated with an area A, which is a predetermined area, and the game is progressed through by progressing through stages such as these.

For example, game stages up to a stage A-1, a stage A-2, a stage A-3, and a stage A-4 are associated in the area A, and the game is progressed through in this stage sequence. This drawing shows the progression screen for the case in which progression has been made through the stage A-1 marked by the symbol c and the stage A-2 marked by the symbol b, and progression is being made through the stage A-3 marked by the symbol a.

The control unit 150 processes for the display unit 130 to display, in the region of the symbol a1, the game characters “Stage A-3” that identify the stage currently being progressed through. The level of achievement starts for example at 0, being added to as the player progresses. The control unit 150 also processes for the display unit 130 to display, in the region of symbol a2, the level of achievement therethrough. At the point of reaching the level of achievement 100, the stage is completed, and transition is made to the next stage. When transition is made to the next stage, the new stage level of achievement starts again at 0, this being added to as the player progresses. When all stages established within the area are completed, that area is cleared. The region of the symbol a3 indicates the strength corresponding to the player, which decreases each time the Forward button is pressed, with further progression through the stage becoming impossible when the strength reaches 0. The strength is restored (increased), for example, by a given amount (for example, 1) for each given period of time (for example 3 minutes). The control unit 150 also processes for the display unit 130 to display the Forward button at the symbol a4. By pressing this button, the level of progression is increased, and the player progresses through the game.

In this case, the game provided by the game device 300 in the present embodiment described above is a game in which game items such as cards are used to progress through the game. Game items such as cards are given to a user. Each game item is allocated with each preselected item-selecting probability previously selected in different item-selecting probabilities. As will be described below, each preset item-selecting probability can be changed to a higher item-selecting probability unless the preset item-selecting probability is the highest probability when predetermined or preselected one or more conditions are satisfied. In some cases, the game item can be, for example, a character card used by the player when battling an opponent, or a card for a game weapon or game protection to be given to a game character. By the player getting such a card, the card can be used to fight in a battle with an opponent while progressing through the game. Thus, by getting a large number of cards, or by getting a card that is more advantageous when fighting in a game battle, the player can progress at an advantage through the game. The game can also give to a player a game item such as a recovery medicine that increases the player's strength and causes the player to recover, so as to reward the user with a predetermined probability each time the player progresses through a game stage.

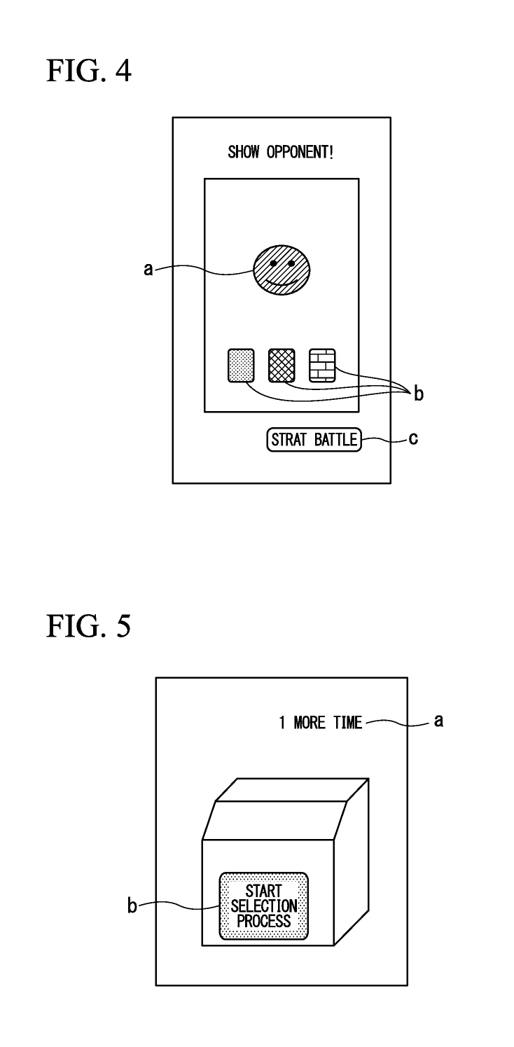

FIG. 4 is a drawing that shows an example of a battle screen when a game event occurs. The control unit 150 performs processing for the display unit 130 to display an image, which shows the opponent in the region of the symbol a. The control unit 150 also performs processing for the display unit 130 to display, in the region of symbol b, cards that are used by the player in the battle with the opponent. The control unit 150 also performs processing for the display unit 130 to display, in the region of symbol c, a Start Battle button, which when pressed performs battle processing.

FIG. 5 is a drawing that shows an example of an item-selection starting screen that is displayed on the display unit 130 when the selection button is pressed. In this case, item-selection process is executed for the player getting a card for use in fighting with an opponent. The control unit 150 performs processing for the display unit 130 to display, in the region of the symbol a, information showing how many times the player can execute the item-selection process (in this drawing “1 more time”). The control unit 150 also performs processing for the display unit 130 to display, in the region of the symbol b, a Start Section button, which when pressed results in execution of item-selection processing.

The number of times that a player can execute the item-selection process may be given a predetermined or preselected condition, for example, of one time during one day. In a situation in which the player cannot execute the item-selection process, the control unit 150 performs processing for the display unit 130 to display information that indicates that the item-selection process cannot be executed, such as to display “0 more times” in the region of symbol a, and also to display “Item-selection process Not Available” in place of the Start Section button.

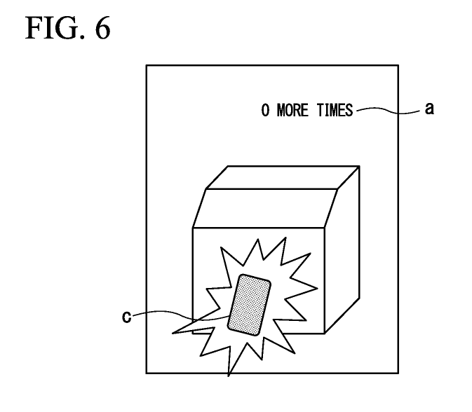

FIG. 6 is a drawing that shows an example of the item-selection results screen that is displayed on the display unit 130 when the Start Section button is pressed to execute the item-selection process in the item-selection starting screen shown in FIG. 5. The control unit 150 changes the information for indicating the number of times the player can execute the item-selection, which is displayed in the region of the symbol a, to “0 more times”. The control unit 150 also performs processing for the display unit 130 to display a card that has been won in the item-selection (that is, the card selected by the item-selection) in the region of the symbol c.

The SNS server 200 is a computer that provides an SNS, this having, for example, a web server function, and providing an SNS based on a pre-established program. The SNS server 200 also relays communication between the user terminal 100 and the game device 300. Although with the configuration shown in FIG. 1 communication between the user terminal 100 and the game device 300 is performed via the SNS server 200, the user terminal 100 and the game device 300 may communicate directly. Although user information, information regarding players, and the relationship between players when a game provided by the SNS server 200 is used can be linked, in the description of the present embodiment the SNS server 200 simply relays communication between the user terminal 100 and the game device 300. In the description that follows, the communication between the user terminal 100 and the game device 300 that is performed by relaying by the SNS server 200 is taken to be simply communication that is performed between the user terminal 100 and the game device 300, and the fact that it is passing through the SNS server 200 is omitted.

The game device 300 is a computer that provides a game to the user terminal 100, and includes a server communication unit 310, a server storage unit 320, a timer unit 330, and a game control unit 340.

The server communication unit 310 communicates with the other computers that are connected via a network.

The server storage unit 320 can be configured by using a recording medium such as RAM (random access memory), ROM (read-only memory), or an HDD (hard-disk drive), or a combination thereof. The server storage unit 320 can be configured to store a program (game program) that is executed by the game device 300 and also to store various information used in providing a game. The server storage unit 320 may include, but is not limited to, a game program storage unit 321, a player information storage unit 322, a game item information storage unit 323, and a item-selection conditions storage unit 324.

The game program storage unit 321 stores a game program that controls a game for providing a game such as described above.

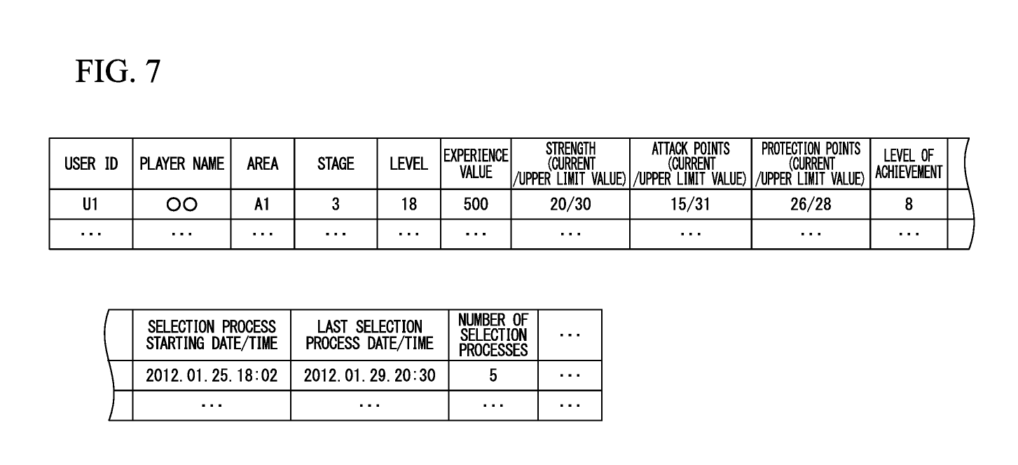

The player information storage unit 322 stores player information, which is information regarding a player who plays a game provided by the game device 300. FIG. 7 is a drawing that shows a data example of player information that is stored in the player information storage unit 322. The player information includes a user ID and player name registered by the player and information that indicates the area, stage, level, experience value, strength with current value and upper limit value, number of attack points with current value and upper limit value, number of protection points with current value and upper limit value, and the level of achievement of the player in the game, the item-selection starting date and time, the immediately previous item-selection date and time, and the number of item-selection processes and the like. The user ID is information used to identify a player who is playing a game provided by the game device 300. The player name is the name of the player corresponding to the user ID, for example, the account name of the player established within the game.

The level is a piece of information that indicates the development of a player within a game, this indicating the stage of strength of the player within the game. For example, an experience value is given to a player as a reward each time the player advances a stage, and when the experience value exceeds an established threshold value, the level value is increased. When the level value increases, the upper limit value of strength, for example, increases. Responsive to the increase in the level value, control can be performed, for example as will be described later, so as to increase the number of attack points and increase the number of cards that can be used in one battle, or to increase the attack strength by the increase in the level of maturation of a game item. The experience value is a kind of reward that is given as a character corresponding to a player proceeds through a stage.

The strength with current value and upper limit value may be a set of values that decreases by the player taking actions within the game. For example, the strength is decreased each time a player proceeds through a stage, and is increased if a certain time elapses without proceeding through a stage. Alternatively, the strength may be increased by using a game item such as recovery medicine. The current value may be a value that increases and decreases as the game progresses, and the upper limit value is the upper limit value at the time of strength recovery. The attack points with current value and upper limit value is the number of points required to take on an opponent in a battle. As will be described later, cards that are used in battles are associated with the number of required points, and a player can select a number of cards of the N cards held by the player himself or herself, where N is a natural number, for example, 50, up to an upper limit of M cards, where M is a natural number not exceeding N, for example, 10, and the player can use these in a battle, as long as the total value of required card points does not exceed the current value of attack points.

The number of attack points decreases by a battle using cards, and increases so as to recover each time a certain amount of time elapses.

The number of protection points with current value and upper limit value are the points actually required when engaged in a battle by an opponent. Similar to the number of attack points, a player can select, of the N cards held by the player himself or herself, the number of cards up to an upper limit of M cards, where M is the natural number, and the player can use these in a battle, as long as the total value of required card points does not exceed the current value of protection points. The number of protection points decreases by a battle using cards, and increases to recover each time a certain amount of time elapses. In this case, the attack points and the protection points may be configured so that they do not decrease at the time of a battle, this being used as a reference at the time of selection of cards to be used. The level of achievement is a value that indicates the degree of progress of the player through the game. The level of achievement may be, for example, a value that starts at zero and increase each time a player progresses through a stage.

The item-selection starting date and time are the date and time that the first item-selection is conducted, of the item-selection processes that are repeated by the player for getting items such as cards. The immediately previous item-selection date and time are the date and time of the last item-selection conducted by the selection unit. The number of item-selection processes is the number of times a player has drawn in an item-selection, that is, the number of times item-selection process has been executed by the selection unit 341. For example, the selection unit 341, in response to executions of item-selection process, causes storage into the player information storage unit 322 of information indicating the item-selection starting date and time, the item-selection date and time of the immediately previous item-selection, or the number of item-selection processes and the like. When, for example, a player has collected all the cards that had been the goals, or when a pre-established item-selection time has elapsed, the information regarding the item-selection is cleared, and storage is done again when the player starts the next item-selection.

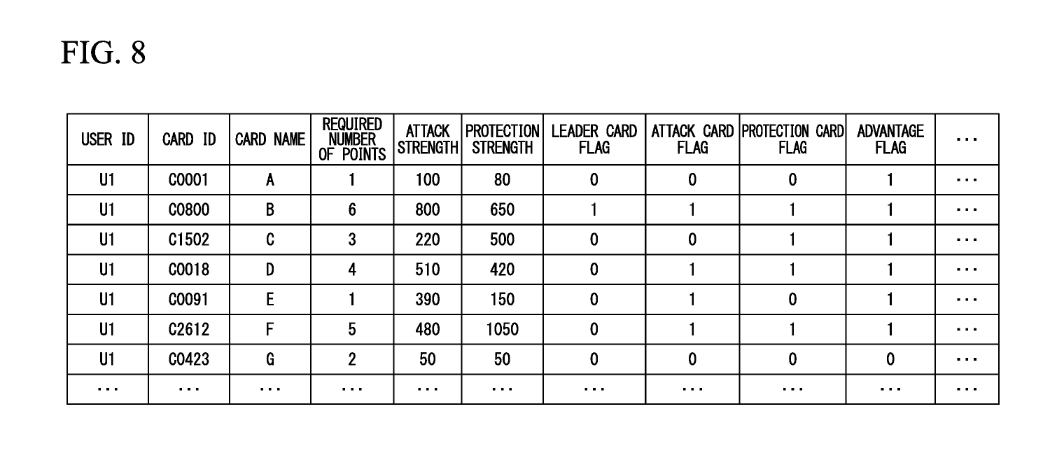

The game item information storage unit 323 stores item information regarding items that the player holds. FIG. 8 is a drawing that shows a data example of game item information stored in the game item information storage unit 323. In this case, the game item information indicates information regarding items such as cards used in a battle, which is associated with a user ID registered by a player and the cards held by the player. The card information includes card IDs, card names, required number of points, attack strength, protection strength, leader card flags, attack card flags, protection card flags, and advantage flags. The card ID is a piece of information that identifies a card. The card name is the name of the card, for example, the name of the character indicated on the card.

The number of required points is a value that indicates the number of attack points or number of protection points required to have a card participate in a battle. The attack strength is an ability value that indicates the degree of damage imparted to an opponent when a card is used in a battle. The protection strength is an ability value that indicates the protection from an attack by an opponent when a card is used in a battle. The leader card flag indicates whether a card of the plurality of cards associated with a player is a card that is to be mainly used. A player specifies any one card of the plurality of cards associated with the player as the leader card. The leader card may be, for example, a card that is used when in a battle in which only one card is used. For example, a leader card flag value of 0 indicates that the card is not the leader card, and a leader card flag value of 1 indicates that the card is the leader card.

The attack card flag is a piece of information pre-establishing whether or not a card is to be used with priority in an attack. The player can set M cards as attack cards among N cards that the player holds, where M and N are the natural numbers and N is greater than M. For example, an attack card flag value of 0 indicates that the card is not selected with priority as a protection card, and an attack card flag value of 1 indicates that the card is selected with priority as a protection card. If there is no protection card flag setting such as this (when there are fewer than M cards having an attack card flag of 1), the game control unit 340 automatically selects a card that is used in a battle.

The protection card flag is a piece of information that pre-establishes whether or not a card is to be used with preference for protection. Similar to the attack card, the player can set M cards as protection cards among N cards that the player holds. For example, a protection card flag value of 0 indicates that the card is not selected with preference as a protection card, and a protection card flag value of 1 indicates that the card is selected with preference as a protection card. If there is no protection card flag setting such as this, the game control unit 340 automatically selects a card that is used in a battle.

The advantage flag is a piece of information that indicates whether or not a card is an advantage card. The term “advantage card” as used here means a predetermined card granted a predetermined advantage when all thereof have been gotten, and whether or not a card is an advantage card is set beforehand for each card individually. For example, an advantage flag value of 1 indicates that the card is an advantage card, and an advantage flag value of 0 indicates that the card is not an advantage card. If, for example, a player collects all L (where L is the natural number, for example, 6) advantage cards, the quantity of which is set beforehand, the player is given a predetermined advantage. The term “predetermined advantage” as used herein refers, for example, to a rare card that is quite difficult for players to get, which is a card having a high value of ability, such as attack strength or protection strength effective for winning a battle. The player gets cards by executing an item-selection during progress through the game.

In addition to the examples given herein, card information (item information) may include, for example, an image indicating the appearance of a game character shown on the card.

Information regarding item-selection conditions when an item-selection for a game item (for example, a card) is executed is stored in the item-selection conditions storage unit 324. The term information regarding the item-selection conditions as used herein includes, for example, information regarding the item-selecting probabilities of the item-selection processes for each of the above-described advantage cards, and information regarding the conditions for re-setting of each of the item-selecting probabilities. The game control unit 340 performs a card selection in accordance with these item-selection conditions, which will be described in detail later.

The timer unit 330 has a function of a clock that is capable of measuring the date and time. The timer unit 330 also has functions of measuring and generating date information and time information in real time. The timer unit 330 transmits the generated date information or time information to the game control unit 340. The timer unit 340 is not limited to a configuration in which it is provided within the game device 300. In some cases, the timer unit 330 may be provided within another device or computer that is connectable via a network to the game device 300 via the server communication unit 310, and may supply the game device 300 with date information and/or time information via the network.

The game control unit 330 may be configured to use a part or all of the cards held by each of a plurality of players (opponents) stored in the player information storage unit 322 to progress through a game for each of a plurality of players, specifically, to progress sequentially through a plurality of stages within a predetermined area. The game control unit 340 generates events during progression through a game played by a player. An event is, for example, an event (battle) that determines winning or losing that is based on an ability value belonging to a card owned by a player and another ability value based on another card owned by an opponent. The game control unit 340 may be configured to conduct an item-selection process executable for a player getting a card to use in a game, in accordance with predetermined or preselected conditions, for example, one time each day. In response to a player executing the item-selection process, the game control unit 340 may be configured to make a drawing for cards in accordance with the item-selecting probability of each of a plurality of cards, and to grant the cards (cards selected by the item-selection) that have been drawn to the player who had executed the item-selection. By doing this, the player gets cards that can be used in a battle.

The configuration of the game control unit 340 will be described in detail. The game control unit 340 has the selection unit 341, a game item granting unit 342, an advantage granting unit 343, a setting unit 344, and an elapsed time detection unit 345.

The selection unit 341 may be configured to conduct an item-selection in accordance with the item-selecting probabilities of each of a plurality of cards. The selection unit 341 may be configured to control, in accordance with predetermined or preselected conditions, whether or not the item-selection process can be executed during the progression through the game of each of the players. For example, the selection unit 341 controls whether or not a card selection can be executed in accordance with the condition of one item-selection process execution being possible each day for one player.

In some cases, if a player has not yet executed an item-selection process on a given day, or if the immediately previous item-selection process execution was yesterday or earlier, the selection unit 341 permits the player to execute the item-selection process. For example, the selection unit 341 performs processing for the display unit 130 to display the Start Section button, such as shown in the display example in FIG. 5, so that the player can draw in an item-selection process for a card. If, however, the player had already executed an item-selection process on that day, the execution of the item-selection process by the player is prohibited. For example, the selection unit 341 performs processing for the display unit 130 to display “Item-selection Process Not Available” in place of the “Start Item-selection Process” in the display example of FIG. 5, so that the player cannot execute the card selection.

The conditions under which the selection unit 341 enables execution of an item-selection process are not restricted to the condition of only one item-selection process per day for one player. For example, the selection unit 341 may limit the use of the item-selection to three times only per day or one time in two days for one player. Also, the selection unit 341 may allow execution of an item-selection process in accordance with the progression status of the player through a game even if the above-described limitation on use prohibits the execution of an item-selection process. For example, the selection unit 341 may allow execution of the item-selection process in accordance with an amount of reduction of points, for example, attack points or protection points, expended in progressing through the game, for example, allowing one item-selection process with respect to a reduction of 100 points.

The game item granting unit 342 may be configured to grant game items to a player in accordance with the results of item-selection process conducted by the selection unit 341. For example, the game item granting unit 342 may be configured to grant to a player that has executed an item-selection process of selecting a card of a plurality of cards, wherein the card granted has been selected in accordance with the results of the item-selection process by the selection unit 341. The game item granting unit 342 may be configured to store, into the game item information storage unit 323, the card as selected in accordance with the item-selection process results, associating it with the user ID of the player.

If the game item granting unit 342 has granted to a player (first player) all of the predetermined game items of a plurality of items, the advantage granting unit 343 grants a predetermined advantage to the player (first player) who had been the recipient. For example, if the game item granting unit 342 has granted the player (first player) all predetermined cards of a plurality of cards, the advantage granting unit 343 grants a predetermined advantage to the player (first player) who was the recipient. In this case, the predetermined cards refer to all the advantage cards with which an advantage is granted by getting the card. The plurality of cards that the selection unit 341 draws in the item-selection process include predetermined or preselected cards having an advantage and other cards having no advantage. For example, if the game item granting unit 342 has granted to a player (a first player) all of the advantage cards of a plurality of cards, the advantage granting unit 343 grants to the granted the player (the first player) who had been granted a predetermined or preselected advantage. For example, the advantage granting unit 343 directs the game item information storage unit 323 to store each advantage card, associated with the player (the first player) who has been granted all of the advantage cards.

The setting unit 344 may be configured to allow setting the selectable range with respect to the cards that are subject to the item-selection process by the selection unit 341 (the cards that have a possibility of being selected by the item-selection process), this being a plurality of cards. For example, the setting unit 344 may be configured to allow setting the selectable range with respect to the advantage cards or with respect to cards that are not advantage cards that are included in a plurality of cards.

At this point, the setting of the selectable range with respect to the advantage cards will be described. The setting unit 344 may be configured to allow setting each of the advantage cards to either a selectable card (first item) or a non-selectable card (second item) that is not the subject of an item-selection process. In this case, the non-selectable cards are cards that have a low item-selecting probability (for example, 0%) with respect to the cards that are the targets of the item-selection process. If the predetermined or preselected conditions are satisfied, the setting unit 344 re-sets at least a part of the non-selectable cards so that they become selectable cards. That is, the setting unit 344, when predetermined or preselected conditions are satisfied, re-sets the selectable range so that at least a part of the non-selectable cards become selectable cards. The setting unit 344, in accordance with the selectable range stored in the above-described item-selection conditions storage unit 324, re-sets the item-selection conditions. The processing of re-setting by the setting unit 341 of the card item-selection conditions in accordance with the card selectable range will be described later in detail.

In the same manner with regard to the selectable range of non-advantage cards as well, the setting unit 344 may be configured to set each of the non-advantage cards to either be a selectable card that is the subject of an item-selection process or a non-selectable card that is not the subject of any item-selection process. With regard to non-advantage cards, the setting unit 344 may set them all to be selectable cards in some cases. The setting unit 344 may set them all to be non-selectable cards in other cases. The setting unit 344 may set them to include both selectable cards and non-selectable cards in still other cases.

The elapsed time detection unit 345 may be configured to detect the elapsed time after the start of an item-selection process by the selection unit 341 upon a request by a player. For example, the elapsed time detection unit 345 may be configured to detect the elapsed time after the start of an item-selection process by the selection unit 341 upon a request by a player, wherein the detection being made based on the date and time information generated by the timer unit 330. In this case, the elapsed time after a the start of an item-selection process by the selection unit 341 upon a request by a player is, for example, the elapsed time from the date and time at the first time that the player performs item-selection process upon being permitted by the selection unit 341 to perform the item-selection process.

As described above, the player information storage unit 322 stores information regarding an item-selection process, such as the item-selection process starting date and time and the item-selection process execution date and time and the like. For example, if a player conducts an item-selection process again, based on information indicating the item-selection process starting date and time stored in the player information storage unit 322 (information indicating the item-selection process starting date and time that is associated with the user ID of a player that is performing an item-selection process once again) and based on the current date and time information or time information (date and time information) generated by the timer unit 330, the elapsed time detection unit 345 detects (calculates) the elapsed time from the start of the item-selection process by the selection unit 341 upon a request by the player, for example, the second day, 30 hours elapsed, or the like. The elapsed time detection unit 345 also supplies information indicating the detected elapsed time to the setting unit 344.

### (Item-Selection Process)

The item-selection process in the game system 1 according to the present embodiment will be described in detail with references made to the drawings.

As described above, in the game of the present embodiment, a player gets cards that are used within the game by performing an item-selection process. The selection unit 341 performs item-selection process targeted at cards among a plurality of cards within a selectable range set by the setting unit 344. The setting unit 344 sets the selectable range in accordance with the item-selection conditions stored in the item-selection conditions storage unit 324. For example, of advantage cards included in the plurality of cards, the setting unit 344 sets the cards that are the targets of the item-selection process. A player who has been granted all of the advantage cards is granted an advantage.

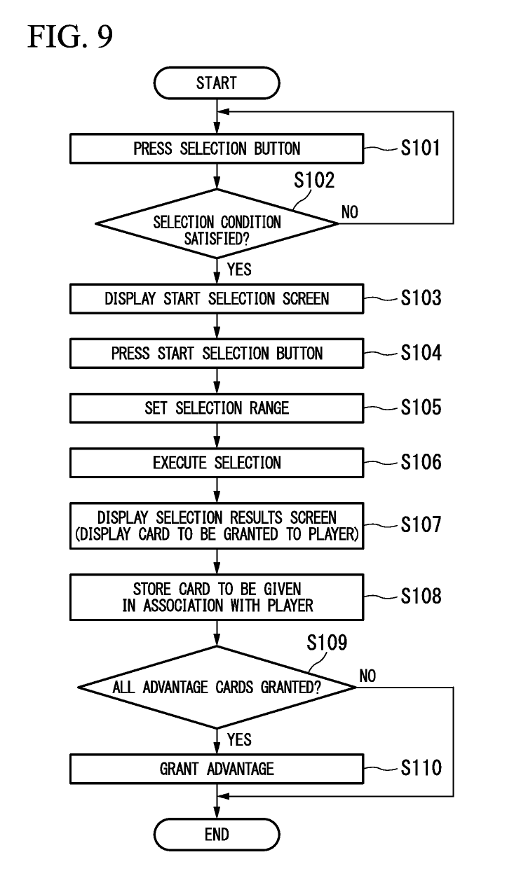

FIG. 9 is a flowchart that shows an example of a series of operation of the item-selection process according to the present embodiment. The flow of the operation of the item-selection process will be described, with references made to this drawing.

First, as pre-processing for the start of the game, the user terminal 100 transmits, to the game device 300, account information that is input by a player, so as to login to the game-providing system of the game device 300. The user terminal 100 transmits to the game device 300 a provision request signal for the game provided by the game device 300. In response thereto, the game device 300 transmits the basic screen of the game to the user terminal 100.

Upon the communication unit 120 of the user terminal 100 receiving the basic screen of the game transmitted from the game device 300, the control unit 150 causes the basic screen of the game received by the communication unit 120 to be displayed on the display unit 130 (refer to FIG. 2). When the Section button included in the basic screen is pressed and instruction information to perform an item-selection process is input to the input unit 110, the control unit 150 transmits a transmission request signal for the item-selection process starting screen to the game device 300, via the communication unit 120 (step S101).

The selection unit 341 of the game device 300, in response to receiving the transmission request signal for the item-selection process starting screen that has been transmitted from the user terminal 100, makes a judgment regarding whether or not the player satisfies the usage conditions for performing an item-selection process (step S102). By doing this, the selection unit 341 judges whether or not to enable the execution of the item-selection process.

If the selection unit 341 judges that the usage conditions for performing an item-selection process are not satisfied (NO at step S102), the game device 300 judges that an item-selection process execution is not possible, and returns processing to step S101. In this case, the game device 300 may transmit to the user terminal 100 information indicating that item-selection process execution is not possible. The user terminal 100 may output information (a display screen, notification sound, or the like) indicating that item-selection process execution is not possible, as notified from the game device 300.

If, however, the selection unit 341 judges that the usage conditions for performing an item-selection process are satisfied (YES at step S102), the game device 300 judges that execution of an item-selection process is possible, and transmits to the user terminal 100 an item-selection process starting screen that includes a Start Section button. Upon the communication unit 120 of the user terminal 100 receiving the item-selection process starting screen transmitted from the game device 300, the control unit 150 of the user terminal 100 causes display of the item-selection process starting screen (refer to FIG. 5) received by the communication 120 on the display unit 130 (step S103).

When the Start Section button included in the item-selection process starting screen displayed on the display unit 130 is pressed and instruction information to execute an item-selection process is input to the input unit 110, the control unit 150 transmits to the game device 300 an item-selection process request signal that request the execution of item-selection process, via the communication unit 120. In response to the receipt of the item-selection process request signal transmitted from the user terminal 100, the selection unit 341 of the game device 300 requests the setting unit 344 to set the selectable range. In response to this request, the setting unit 344, in accordance with the item-selection conditions stored in the item-selection conditions storage unit 324, sets the selectable range (cards that are the targets of the selection) (step S105). A specific example of the processing to set the selectable range will be described in detail later.

The selection unit 341 of the game device 300 performs item-selection process, in accordance with each of the card item-selecting probabilities responsive to the selectable range set by the setting unit 344 (step S106). The game device 300 transmits to the user terminal 100 item-selection results screen that includes information indicating the card drawn (card selected by the item-selection process) by the execution of the item-selection process. Upon receipt of the item-selection process results screen transmitted by the communication unit 120 of the user terminal 100 from the game device 300, the control unit 150 causes display on the display unit 130 of the item-selection process results screen (refer to FIG. 6) that has been received by the communication unit 120 (step S107). That is, the control unit 150 causes display on the display unit 130 of the card selected in accordance to the item-selection process results, which is to be given to the player.

The game item granting unit 342 of the game device 300 causes the game item information storage unit 323 to store, in association with the user ID of a player, the card that has been selected and granted to the player in response to the item-selection process results of the selection unit 341 (step S108). The selection unit 341 may cause storage into the player information storage unit 322 of the time of the execution of the item-selection process, in association with the user ID of the player. For example, if a player is performing an item-selection process for the first time, the selection unit 341 may cause storage into the player information storage unit 322 of the time of execution of the item-selection process as the item-selection process starting date/time and the immediately previous item-selection process execution date/time, associated with the user ID of the player. If the player is performing an item-selection process on the second or a subsequent time, the selection unit 341 may cause storage into the player information storage unit 322 of the time of execution of the item-selection process as the immediately previous item-selection process execution date/time, associated with the user ID of the player.

The advantage granting unit 343 of the game device 300 makes a judgment regarding whether or not the player who had been granted the above-noted card has been granted all of the advantage cards (step S109). If the judgment by the advantage granting unit 343 is that all the advantage cards have been granted (YES at step S109), a predetermined advantage is granted to the player. For example, the advantage granting unit 343 causes storage into the game item information storage unit 323 of a card to be granted as the predetermined advantage, with respect to the player to whom all the advantage cards have been granted (step S110). In the case of the advantage granting unit 343 granting an advantage to a player, by the game device 300 transmitting an advantage granting screen that includes information indicating the granting of an advantage to the user terminal 100, the control unit 150 of the user terminal 100 causes display of the received advantage granting screen on the display unit 130.

The game device 300 then ends the item-selection process, and transmits the game basic screen to the user terminal 100. The control unit 150 of the user terminal 100 causes display of the basic screen received from the game device 300 on the display unit 130, and ends the item-selection process.

If, however, the judgment by the advantage granting unit 343 is that all of the advantage cards have not been granted (NO at step S109), the player is not granted an advantage. Then, as described above, the game device 300 and the user terminal 100 end the item-selection process.

Referring the drawing, a specific example of selectable range setting processing at step S105 in FIG. 9 will be described.

In this case, the cards that can be gotten within the game are the 26 cards from A to Z. Of the cards A to Z, the six cards A to F are advantage cards, and the 20 cards G to Z are non-advantage cards. If all the six cards A to F are granted to a player, the player is granted an advantage. Thus, the player performs an item-selection process of cards so as to get all of the six cards A to F, which are advantage cards, and progresses through the game.

Although the selection unit 341 performs an item-selection process in accordance with the probabilities set by the setting unit 344 for each of the 26 cards A to Z, in the present embodiment, because the item-selecting probabilities of advantage cards are re-set in accordance with a predetermined or preselected condition, in the description to follow, the item-selection process for the six cards A to F, which are advantage cards, will be described. The 20 cards G to Z, which are non-advantage cards, may either be or not be targets of the item-selection process.

The setting unit 344 of the game device 300, in accordance with the item-selection conditions that are stored in the item-selection conditions storage unit 324, sets the item-selecting probability of each of the cards (that is, the selectable range for the targets of the item-selection process). As described above, the item-selection conditions storage unit 324 stores, for example, as information regarding item-selection conditions when executing an item-selection process for a card, information regarding the item-selecting probability for each selection target card, and information regarding the conditions for setting each of the item-selecting probabilities (re-setting conditions). Specifically, the item-selection conditions storage unit 324 stores predetermined or preselected conditions for triggering the re-setting of the item-selecting probability for each of the cards, and information indicating of which of the cards the item-selecting probability is to be re-set if those predetermined or preselected conditions are satisfied (the selectable range after the re-setting if the predetermined or preselected conditions are satisfied), these being stored in association with one another.

In this case, the predetermined or preselected condition for triggering the re-setting of the item-selecting probabilities for each of the cards is a condition based on the status of progress through the game. A condition based on the status of progress through the game is, for example, the status of card granting, the amount of time elapsed from when the player started the item-selection process, and the number of time a player has drawn in an item-selection process. In addition to these conditions, a condition based on the status of progress through the game may be the status of progress (area or stage) of a player within the game, a level, an experience value, strength, attack points, protection points, and level of achievement or the like of the player.

### (Example of Re-Setting of the Item-Selecting Probability Responsive to the Card Granting Status)

First, an example of the setting unit 344, in accordance with the card granting status with respect to a player, re-setting the card selectable range (re-setting of the item-selecting probability) of advantage cards will be described.

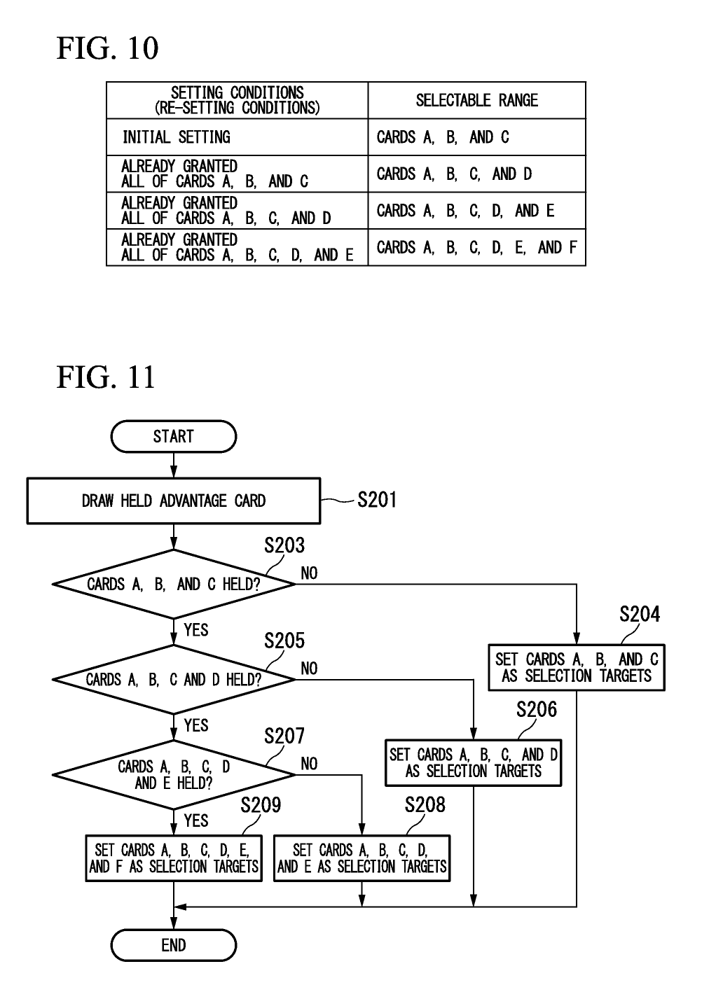

FIG. 10 shows the first example of item-selection conditions stored in the item-selection conditions storage unit 324. The drawing is an example of the predetermined or preselected conditions that trigger re-setting of the selectable range and information that indicates the selectable range after re-setting for the case in which a predetermined or preselected condition is satisfied, this example being for the case in which the predetermined or preselected condition for triggering re-setting of the selectable range is a condition based on the card granting status. In the example shown in FIG. 10, the condition indicating that all the selectable cards (first items) are granted to the player is the condition based on the above-described card granting status. If all the selectable cards (first game items) have been granted to the player, the setting unit 344, based on the item-selection conditions shown in FIG. 10, re-sets the selectable range, the predetermined or preselected conditions having been satisfied.

First, as the first selectable range (initial setting), the setting unit 344 sets the cards A, B, and C of the cards A to F as the selectable range. By doing this, the selection unit 341 performs the item-selection process from the three cards A, B, and C, with the item-selection targets as cards A, B, and C. With this setting, of the cards A to F, the cards D, E, and F have a low item-selecting probability (0%) relative to that of the cards A, B, and C (first game items). In this case, the cards that are the targets of the item-selection process (cards A, B, and C with the initial settings) are called the first game items, and the non-selectable cards that have an item-selecting probability that is lower than that of the first game items (cards D, E, and F with the initial settings) are called the second game items.

In the initial settings, when all of the cards A, B, and C (first game items) have been granted to a player, the setting unit 344 makes a re-setting, with the card D of the cards D, E, and F (second game items) added to the cards A, B, and C (first game items), thereby re-setting the selectable range to the cards A, B, C, and D. That is, of the second items (cards D, E, and F), the card D is re-set by the setting unit 344 to be a first game item. Thus, the first game items become the cards A, B, C, and D, and the second game items are cards E and F. By doing this, the selection unit 341 performs the item-selection process from the four cards A, B, C, and D, with cards A, B, C, and D as the targets of the item-selection.

In the setting of cards A, B, C, and D as the item-selection targets (first game items), when all of the cards A, B, C, and D have been granted to the player, the setting unit 344 makes a re-setting, with the card E of the cards E and F (second game items) added to the cards A, B, C, and D (first game items), thereby re-setting the selectable range to the cards A, B, C, D, and E. Of the second items (cards E and F), the card E is re-set by the setting unit 344 to be a first game item. The first game items become the cards A, B, C, D, and E, and the second game item becomes the card F. By doing this, the selection unit 341 performs the item-selection process from the five cards A, B, C, D, and E, with the cards A, B, C, D, and E as the targets of the item-selection.

In the setting of the cards A, B, C, D, and E as the item-selection targets (first game items), when all of the cards A, B, C, D, and E have been granted to the player, the setting unit 344 makes a re-setting, with the remaining card F (second game items) added to the cards A, B, C, D, and E (first game items), thereby re-setting the selectable range to the cards A, B, C, D, E, and F (all the advantage cards). The remaining card F (second game items) is re-set by the setting unit 344 to be a first game item. Thus, the first game items become the cards A, B, C, D, E, and F, which are all of the advantage cards.

By doing this, the selection unit 341 performs the item-selection process from the selectable cards A, B, C, D, E, and F, which are all of the advantage cards.

FIG. 11 is one example of the selectable range setting processing at step S105 in the item-selection process shown in FIG. 9, this being a flowchart that shows the operation in the processing to re-set the selectable range in accordance with the item-selection conditions shown in FIG. 10.

The setting unit 344, referring to the game item information storage unit 322, draws an advantage card held by the player (step S201). The setting unit 344, based on the results of the item-selection for advantage cards, makes a judgment regarding whether or not the player performing the item-selection process is holding all of the cards A, B, and C (step S203). If the setting unit 344 judges that there is one or more of the cards A, B, and C that the player performing the item-selection process does not hold (NO at step S203), the setting unit 344 sets the cards A, B, and C as the item-selection targets (selectable range) (step S204).

If, however, the setting unit 344 judges that the player performing the item-selection process holds all of the cards A, B, and C (YES at step S203), the setting unit 344 judges whether or not the player performing the item-selection process holds all of the cards A, B, C, and D (step S205). If the setting unit 344 judges that there is one or more of the cards A, B, C, and D that the player performing the item-selection process does not hold (NO at step S205), that is, that the player holds all of the cards A, B, and C, but does not hold card D, the setting unit 344 re-sets the cards A, B, C, and D as the item-selection targets (selectable range) (step S206).

If, however, the setting unit 344 judges that the player performing the item-selection process is holding all of the cards A, B, C, and D (YES at step S205), a judgment is made regarding whether or not the player performing the item-selection process is holding all of the cards A, B, C, D, and E (step S207). If the setting unit 344 judges that there is one or more of the cards A, B, C, D, and E that the player performing the item-selection process does not hold (NO at step S207), that is, that the player holds all of the cards A, B, C and D, but does not hold card E, the setting unit 344 re-sets the cards A, B, C, D, and E as the item-selection targets (selectable range) (step S208).

If, however, the setting unit 344 judges that the player performing the item-selection process is holding all of the cards A, B, C, D, and E (YES at step S207), the setting unit 344 re-sets the cards A, B, C, D, E, and F (all of the advantage cards) at the item-selection targets (selectable range) (step S209).

As described above, the setting unit 344 of the game device 300 sets each of the selection target cards to either be an item-selection process target card (first game item) or a non-advantage cards (second game item) that is not the target of the selection. When a predetermined or preselected condition is satisfied, the setting unit 344 performs re-setting so that at least a part of the cards that are not item-selection targets so as to be selection target cards. For example, the setting unit 344, in accordance with the status of cards granted to a player, re-sets the selection target cards of the advantage cards. As an example, if all of the selection target cards of the advantage cards have been granted to the player, the setting unit 344 performs re-setting of at least a part of the non-selection target cards included in the advantage cards to be selection target cards. That is, when a predetermined or preselected condition is satisfied, the setting unit 344 re-sets the selectable range so that at least a part of the non-selection target cards to be selection target cards.

By doing this, in response to the status of card granting, for example, if all of the selection target cards of the advantage cards have been granted to the player, the game device 300 can perform re-setting of at least part of the non-selection target cards included in the advantage cards so as to be selection target cards. The game device 300, responsive to a predetermined or preselected condition, such as the status of granting of cards, can change the item-selecting probabilities for cards to be drawn in an item-selection process. Thus, even when the game device 300 grants cards to a player in an item-selection process, it is possible for the player to continue to enjoy the game.

The game device 300, responsive to the status of granting cards to a player, in response to the granting to a player all of the selection target cards of the advantage cards, adds cards that initially had not been selection target cards of the advantage cards to the selection target cards. By doing this, the game device 300 increases the selection target cards in response to the status of card granting, so that it is possible to encourage the player to perform an item-selection process.

The condition under which the setting unit 344 of the game device 300 re-sets the selectable range in response to the status of the granting of cards is not restricted to the condition of all of the selection target cards of the advantage cards being granted to the player. For example, the setting unit 344 may re-set the selectable range in response to a player having been granted 80% of the selection target cards of the advantage cards.

(Example of Re-Setting of the Item-Selecting Probability in Response to the Elapsed Time after the Start of Item-Selection)

An example in which the setting unit 344 re-sets the selectable range of advantage cards (re-sets the item-selecting probability) in response to the time elapsed after the start of an item-selection process by the selection unit 341 upon a request by a player will be described.

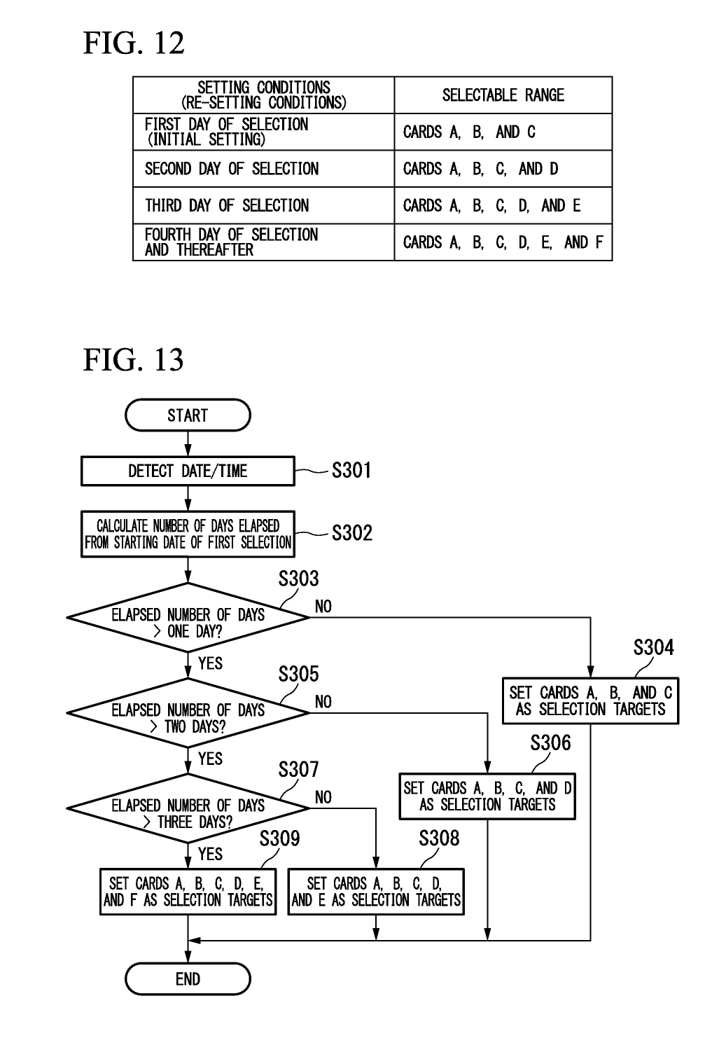

FIG. 12 is a table that shows a second example of the item-selection conditions stored in the item-selection conditions storage unit 324. This table shows one example of the predetermined or preselected conditions that trigger a re-setting of the selectable range, and information that indicates the selectable range after re-setting for the case in which a predetermined or preselected condition is satisfied, where the predetermined or preselected conditions are based on the time elapsed after the start of the item-selection process. The predetermined or preselected conditions that trigger a re-setting of the selectable range are set beforehand as a threshold value of elapsed time after the start of the item-selection process. When the elapsed time detected by the detection unit 345 exceeds the threshold set beforehand, the predetermined or preselected condition having been satisfied, the setting unit 344 re-sets the selectable range, based on the item-selection conditions shown in FIG. 12.

In the example shown in FIG. 12, the four threshold values of the first, second, and third, and the fourth days of the item-selection process and thereafter are set beforehand as the threshold values of elapsed time after the start of the item-selection process. These threshold values that are set beforehand are associated with selectable ranges after re-setting, which include cards to be re-set as item-selection process targets of the non-selectable cards (second game item), and these are stored as item-selection conditions in the item-selection conditions storage unit 324. That is, the item-selection conditions are stored beforehand in the item-selection conditions storage unit 324 as a schedule to re-set the selectable range in accordance with satisfaction of the pre-set threshold value. Thus, if the judgment is that the elapsed time, which has been detected by the elapsed time detection unit 345 in accordance with this re-setting schedule, reaches or exceeds the threshold value that has been set beforehand, the predetermined or preselected condition for triggering the re-setting of the selectable range having been satisfied, the setting unit 344 performs re-setting of a card among the non-selectable cards (second game items) so that it is within the selectable range after re-setting corresponding to the threshold value.

First, on the day that the player starts an item-selection process (first day after starting the item-selection process), as the initial setting of the first day of the selectable range, the setting unit 344 sets the cards A, B, and C (first game items) of the cards A to F as the selectable range.

If the day reaches the second item-selection process day, the setting unit 344 performs re-setting to the cards A, B, C, and D as the selectable range, by adding the card D of the cards D, E, and F (second game items) to the cards A, B, and C (first game items). That is, the setting unit 344 re-sets the card D of the second game items (cards D, E, and F) as a first game item. Thus, the first game items become the cards A, B, C, and D, and the second game items become the cards E and F. By doing this, the selection unit 341 draws from the four cards A, B, C, and D, with the cards A, B, C, and D as the item-selection targets.

If the day reaches the third item-selection process day, the setting unit 344 performs re-setting to the cards A, B, C, D and E as the selectable range, by adding the card E of the cards E and F (second game items) to the cards A, B, C, and D (first game items). That is, the setting unit 344 re-sets the card E of the second game items (cards E and F) as a first game items. Thus the first game items become the cards A, B, C, D, and E, and the second game item is the card F. By doing this, the selection unit 341 draws from the five cards A, B, C, D, and E, with the cards A, B, C, D, and E as the item-selection targets.

If the day reaches the fourth item-selection process day, the setting unit 344 performs re-setting to the cards A, B, C, D, E, and F (all the advantage cards) as the selectable range, by adding the remaining card F (second game item) to the cards A, B, C, D, and E (first game items). That is, the setting unit 344 re-sets the card F, which is a second game item (remaining card F), as a first game item. Thus, the first game items are the cards A, B, C, D, E, and F, that is, all of the advantage cards. By doing this, the selection unit 341 draws from all of the advantage cards, with the cards A, B, C, D, E, and F as the item-selection targets.

FIG. 13 is a second example of the selectable range setting processing of step S105 in the item-selection process shown in FIG. 9, this being a flowchart that shows the operation in the processing of re-setting the selectable range in accordance with the item-selection conditions shown in FIG. 12.

The elapsed time detection unit 345, in response to the player pressing the Start Section button, acquires the current date/time from the timer unit 330 (step S301). Then, based on the acquired information indicating the current date/time and information indicating the starting date/time of the item-selection process that is stored in the player information storage unit 322 (information indicating the item-selection process day/time associated with the user ID of the player who is performing item-selection process), the elapsed time detection unit 345 detects (calculates) the elapsed time (elapsed number of days in FIG. 13) from the date/time at which the first item-selection process was started by the player (step S302).

The setting unit 344 makes a judgment regarding whether the number of elapsed days detected by the elapsed time detection unit 345 exceeds one day (step S303). If the number of elapsed days detected by the elapsed time detection unit 345 does not exceed one day (NO at step S303) (that is, in the case of the first item-selection process day), the setting unit 344 sets the cards A, B, and C as the item-selection targets (selectable range) (step S3404). If the information indicating the item-selection process starting date/time that is stored in the player information storage unit 322 is cleared (the case in which the information indicating the item-selection process starting date/time has not yet been input), that is, if the player is performing an item-selection process for the first time, the setting unit 344, in the same manner, sets the cards A, B, and C as the item-selection process targets (selectable range).

If, however, the judgment is that the number of elapsed days detected by the elapsed time detection unit 345 exceeds one day (YES at step S303), the setting unit 344 makes a judgment regarding whether or not the number of elapsed days exceeds two days (step S305). If the judgment is that the number of elapsed days detected by the elapsed time detection unit 345 does not exceed two days (that is, in the case of the second item-selection process day) (NO at step S305), the setting unit 344 re-sets the cards A, B, C, and D as the item-selection targets (selectable range) (step S306).

If, however, the judgment is that the number of elapsed days detected by the elapsed time detection unit 345 exceeds two days, the setting unit 344 makes a judgment regarding whether or not the number of elapsed days exceeds three days (step S307). If the judgment is that the number of elapsed days detected by the elapsed time detection unit 345 does not exceed three days (that is, in the case of the third day) (NO at step S307), the setting unit 344 re-sets the cards A, B, C, D, and E as the item-selection targets (selectable range) (step S308).

If, however, the judgment is that the number of elapsed days detected by the elapsed time detection unit 345 exceeds three days (YES at step S307), the setting unit 344 re-sets the cards A, B, C, D, E, and F (all of the advantage cards) as the item-selection targets (selectable range) (step S309).

In this manner, if a condition based on the amount of time elapsed after the start of an item-selection process by the selection unit 341 upon a request by a player is satisfied, the setting unit 344 re-sets at least a part of the non-selectable cards (second game items) to be selection target cards (first game items). For example, if the amount of time elapsed after the start of the item-selection process detected by the elapsed time detection unit 345 is judged by the setting unit 344 to be at or above a previously established threshold value, with the predetermined or preselected condition for re-setting the selectable range being satisfied, the setting unit 344 re-sets at least a part of the game items of the non-selection cars (second game items) as selection target cards (first game items). In the case in which the predetermined or preselected condition is satisfied, the setting unit 344 re-sets the selectable range so that at least a part of the non-selectable cards become selection target cards.

By doing this, the game device 300, in response to the amount of time elapsed after the start of the item-selection process, can re-set at least a part of the non-selectable cards included in the advantage cards so as to become selection target cards. That is, the game device 300, in accordance with a predetermined or preselected condition such as the elapsed time, can change the item-selecting probability for cards that are drawn. Thus, even when the game device 300 grants cards to a player in an item-selection process, it is possible to grant cards for the player to continue to enjoy the game.

The game device 300, responsive to the elapsed time after the start of the item-selection process, adds cards that were initially (at the time of the start of the item-selection process) non-selection target cards to the selection target cards. By doing this, the game device 300 increases the selection target cards in response to the elapsed time, so that it is possible to encourage the player to perform an item-selection process.

Although the foregoing has been a description, referring to FIG. 12 and FIG. 13, of an example of re-setting the selectable range (re-setting the item-selecting probability) of advantage cards, in response to the elapsed time (elapsed number of days) from the start of an item-selection process by the selection unit 341 upon a request by a player, this is not a restriction. For example, the setting unit 344 may, in response to the elapsed time (number of elapsed days) from the starting date/time (starting date) of special item-selection event held during a predetermined time period, re-set the selectable range (re-set the item-selecting probability) of advantage cards. In this case, the predetermined period of time is a period of time that is established beforehand by the operator of the game, and the starting date/time of the special item-selection event (starting date) is, for example, is the first date or date/time of the period of time (predetermined period of time) for holding the special item-selection event, which is set beforehand by the operator of the game. That is, the setting unit 344 may, without regard to an action of a player with respect to a game, such as the player pressing the Section button to perform an item-selection process, re-set the selectable range (re-set the item-selecting probability) in response to the elapsed time (elapsed date/time) from the starting date/time (starting date) of a special item-selection event that is held in a predetermined period of time.

The above-described special item-selection event is, for example, an event such as one that grants a predetermined advantage to a player who has been granted all the advantage cards. Also, the above-described predetermined period of time is not restricted to the above-described special advantage event, and may be a period of time of holding another event that is established by the operator of the game.

If the selectable range is re-set in response to the elapsed time from the starting date of a special advantage event, for example in the selectable range setting processing shown in FIG. 13, the processing of step S302 can be made as follows.

For example, at step S302, the elapsed time detection unit 345, based on the current date/time acquired at step S301 and information indicating the starting date/time of the special advantage event, detects (calculates) the elapsed time after the start of the special advantage event (the elapsed number of days in FIG. 13).

The information that indicates the starting date/time of the special advantage event is stored, for example, in the item-selection conditions storage unit 324.

That is, the elapsed time detection unit 345, based on information indicating the starting date/time of a special item-selection event that is information read from the item-selection conditions storage unit 324 that indicates the starting date/time of the special advantage event, and based on information that indicates the current date/time acquired at step S301, detects (calculates) the elapsed time (elapsed number of days in FIG. 13) after the starting date/time of the special advantage event.

In this manner, if a condition based on the elapsed time after the starting date/time of a special advantage event is satisfied, the setting unit 344 re-sets at least a part of the game items of the non-selectable cards (second game items) as selectable cards (first game items). For example, if a judgment is made that the elapsed time after the start of a special advantage event that has been detected by the elapsed time detection unit 345 is equal to or exceeds a pre-established threshold value, with the predetermined or preselected condition for re-setting the selectable range satisfied, the setting unit 344 re-sets at least a part of the non-selectable cards (second game items) as selectable cards (first game items). That is, if the predetermined or preselected condition is satisfied, the setting unit 344 re-sets the selectable range so that at least a part of the non-selectable cards becomes selectable cards.

By doing this, the game device 300, in response to the elapsed time after the start of the special advantage event, can re-set at least a part of the non-selectable cards included in the advantage cards so as to become selectable cards. That is, the game device 300 can, responsive to a predetermined or preselected condition such as the elapsed time, change the item-selecting probability of cards that are drawn. Thus, even when the game device 300 grants cards to a player in an item-selection process, it is possible to grant cards for the player to continue to enjoy the game.

### (Example of Re-Setting of the Item-Selecting Probability Responsive to Other Conditions)

Although the foregoing have been descriptions, using FIG. 10 and FIG. 13, of examples in which a condition based on the status of card granting and a condition based on the elapsed time after the start of an item-selection process are the predetermined or preselected condition that acts as a trigger for the re-setting of the item-selecting probability, these are not restrictions. For example, the predetermined or preselected condition for triggering the re-setting of the item-selecting probability may be another condition other than the above-described conditions, for example, a condition based on the number of item-selection processes that are as item-selection processes executed by the selection unit upon instructions by a player.

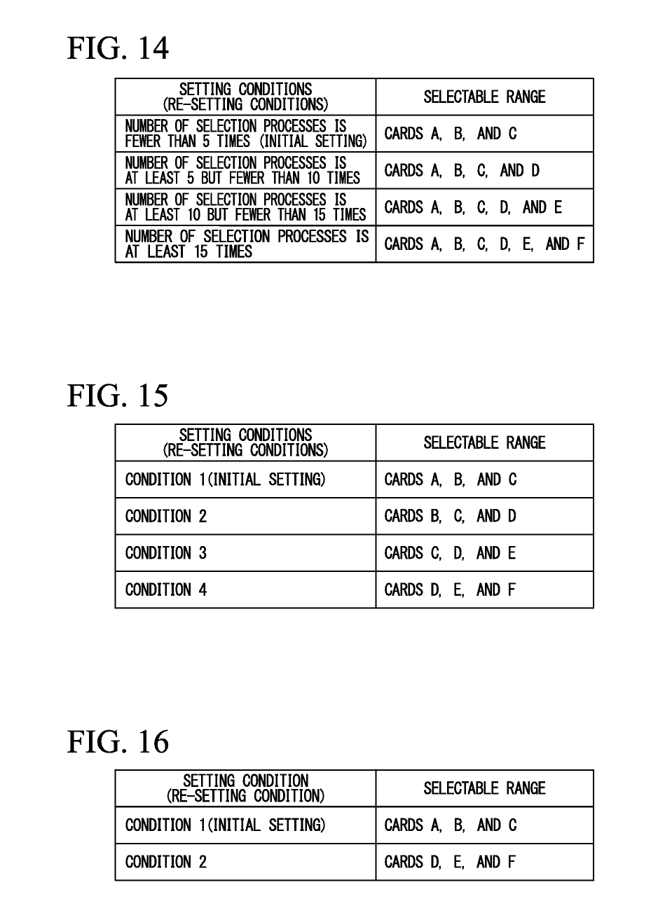

FIG. 14 is a table of a third example of the item-selection conditions stored in the item-selection conditions storage unit 324.

This table is an example that shows the predetermined or preselected conditions for triggering the re-setting of the selectable range and information that indicates the selectable range after re-setting when the conditions are satisfied, this being an example of the case in which the predetermined or preselected condition that acts as a trigger for a re-setting of the selectable range is a condition based on the number of item-selection processes. That is, FIG. 14 shows an example in which the conditions (setting conditions) for triggering the re-setting of the selectable range shown in FIG. 10 or FIG. 12 are replaced by a condition based on the number of item-selection processes. The setting unit 344 re-sets the selectable range based on the item-selection conditions shown in FIG. 14.

The setting unit 344 sets the initial selectable range (initial setting) and the selectable range if the number of item-selection processes is less than five times, setting the cards A, B, and C of the cards A to F as the selectable range.

If the number of item-selection processes at least five but fewer than 10 times, the setting unit 344 re-sets the selectable range so that the card D of the cards D, E, and F (second game items) is added to the cards A, B, and C (first game items), making the cards A, B, C, and D be the selectable range.

If the number of item-selection processes is as least 10 but fewer than 15 times, the setting unit 344 re-sets the selectable range so that the card E of the cards E and F (second game items) is added to the cards A, B, C, and D (first game items), making the cards A, B, C, D, and E be the selectable range.

Additionally, if the number of item-selection processes is as least 15 times, the setting unit 344 re-sets the selectable range so that the remaining second game items card F is added to the cards A, B, C, D, and E (first game items), making the cards A, B, C, D, E, and F (all the advantage cards) be the selectable range.

In this manner, if a condition based on the number of times a player has executed an item-selection process is satisfied, the setting unit 344 re-sets at least a part of the non-selectable cards (second game items) as selectable cards (first game items). That is, the game device 300, in response to a predetermined or preselected condition such as the number of times a player has executed an item-selection process, can change the item-selecting probability of the cards that are drawn. Thus, even when the game device 300 grant cards to a player in an item-selection process, it is possible to grant cards to the player so that the player continue to enjoy the game.

The game device successively adds cards that were initially non-selectable cards (at the time of the start of the item-selection process) to the selectable cards, in accordance with the increase in the number of item-selection process times. By doing this, the game device 300 increases the item-selection target cards in response to the increase in the number of times a player instructed the selection unit to perform an item-selection process, so that it is possible to encourage the player to perform an item-selection process.

The status of granting of cards, the elapsed time after the start of an item-selection process, and the number of item-selection processes are the status of progress through a game by a player, according to item-selection results. The setting unit 344 may re-set the item-selecting probability, not limited to a condition based on these results of an item-selection process, but rather based on another status of progress through a game. For example, the setting unit 344 may re-set the item-selecting probability in accordance with the area or stage being progressed through by the player, the level, the experience value, the strength, the number of attack points, the number of protection points, and the level of achievement and the like of the status of progression of the player. That is, the predetermined or preselected condition that triggers the re-setting of the item-selecting probability may be a condition that is based on the area or stage being progressed through by the player, the level, the experience value, the strength, the number of attack points, the number of protection points, and the level of achievement and the like of the status of progress through a game. By doing this, the game device 300 can change the item-selecting probability of cards that are drawn in response to the status of progress through the game by the player. Because the game device 300 increases the selection target cards in response to the status of progress through the game by the player, it is possible to encourage the player to play the game.

### (Another Example of Re-Setting of the Selectable Range)

Although in the above description of an example of re-setting the selectable range using the FIG. 10 to FIG. 14, if a predetermined or preselected condition is satisfied, the setting unit 344 adds at least a part of the non-selectable cards (second game items) to the selectable cards (first game items) as selectable cards (first game items), this is not a restriction. If the predetermined or preselected condition is satisfied, the setting unit 344 can re-set at least a part of the non-selectable cards (second game items) as selectable cards (first game items) and, for example, may perform re-setting of at least a part of the selectable cards (first game items) as non-selectable cards and at least a part of the non-selectable cards (second game items) as selectable cards (first game items). Another specific example of the re-setting of the selectable range will be described below, using FIG. 15 and FIG. 16.

FIG. 15 is a table that shows a fourth example of item-selection conditions stored in the item-selection conditions storage unit 324.

The item-selection condition settings shown in this table are an example of re-setting, in the case of satisfying a predetermined or preselected condition, at least a part of the selectable cards (first game items) to make them non-selectable cards, and at least a part of the non-selectable cards (second game items) to make them selectable cards (first items). In this table, the predetermined or preselected conditions for triggering re-setting of the selectable range are conditions 1 to 4, and may be any of the conditions in the examples shown in FIG. 10, FIG. 12, and FIG. 14.

In the case of the condition 1 (initial setting), the setting unit 344 sets the cards A, B, and C of the cards A to F as the selectable range.

In the case of the condition 2, the setting unit 344 excludes the card A of the cards A, B, and C (first game items) from the selectable range and adds the card D of the cards D, E, and F (second game items) to the selectable range, thereby making the selectable range be the cards B, C, and D.

If the condition 3 is satisfied, the setting unit 344 excludes the card B of the cards B, C, and D (first game items) from the selectable range and adds the card E of the cards E, F, and A (second game items) to the selectable range, thereby making the selectable range be the cards C, D, and E.

Additionally, if the condition 4 is satisfied, the setting unit 344 excludes the card C of the cards C, D, and E (first game items) from the selectable range and adds the card F of the cards F, A, and B to the selectable range, thereby making the selectable range be the cards D, E, and F.

FIG. 16 is a table that shows a fifth example of item-selection conditions stored in the item-selection conditions storage unit 324.

The item-selection condition settings shown in this table are an example of re-setting, in the case of satisfying a predetermined or preselected condition, all of the selectable cards (first game items) to make them non-selectable cards, and all of the non-selectable cards (second game items) to make them selectable cards (first game items).

In the case of the condition 1 (initial setting), the setting unit 344 sets the cards A, B, and C of the cards A to F as the selectable range.

In the case of the condition 2, the setting unit 344 excludes all of the cards of the cards A, B, C (first game items) from the selectable range and makes the cards D, E, and F of the cards D, E, and F (second game items) be the selectable range, thereby making the selectable range be the cards D, E, and F.

Although the above has been descriptions of the first example to the fifth example of item-selection conditions that are stored in the item-selection conditions storage unit 324, referring to FIG. 10 to FIG. 16, it is possible to make an arbitrary combination of each of the first example to the fifth example of item-selection conditions. For example, a part of or all of the item-selection conditions of the above-described first to fifth examples may be stored in the item-selection conditions storage unit 324, and the setting unit 344 may set or re-set the selectable range of a plurality of cards, in accordance with item-selection conditions that are a combination of a part of or all of the first example to the fifth example of item-selection conditions read from the item-selection conditions storage unit 324. Also, a combination of a part of or all of the item-selection conditions of the above-described first to fifth examples may be stored in the item-selection conditions storage unit 324, and the setting unit 344 may set or re-set the selectable range of a plurality of cards, in accordance with the combination of item-selection conditions.

For example, item-selection conditions may be used that are the combination of the first example described with reference to FIG. 10 and FIG. 11 and the second example described with reference to FIG. 12 and FIG. 13. The setting unit 344 may set or re-set the selectable range in accordance with item-selection conditions that are based on both the card granting status shown in FIG. 10 and the elapsed time shown in FIG. 12. For example, the setting unit 344 sets the cards A, B, and C of the Cards A to F, as the initial setting of the selectable range. If a player has already been granted all of the cards A, B, and C (first game items), or if the second day of the item-selection process is reached, whichever comes first, the setting unit 344 makes the selectable range be the cards A, B, C, and D, which had added to them the card D of the cards D, E, and F (second game items). Thereafter, if each of the setting conditions (re-setting conditions) shown in FIG. 10 is satisfied, or if each of the setting conditions (re-setting conditions) shown in FIG. 12 is satisfied, whichever comes first, the setting unit 344 re-sets the corresponding selectable range.

By doing this, the game device 300 can re-set at least a part of the non-selectable cards included in the advantage cards so as to become selectable cards, in response to the card granting status with respect to a player and the elapsed time after the start of the item-selection process or after the start of an event. That is, the game device 300 can change the item-selecting probability of cards that are drawn, in response to predetermined or preselected conditions, such as the card granting status or elapsed time. Because the game device 300 increases the selection target cards in response to the various progression statuses of the game by combining a plurality of item-selection conditions, it is possible to encourage the player to perform an item-selection process.

The selection unit 341 may re-set cards that have already been granted to a player so as to be non-selectable cards. For example, the selection unit 341 may re-set, in accordance with a request for item-selection process by the selection unit 341 upon a request by a player, of a plurality of cards, cards excluding cards associated with the player in the game item information storage unit 323, as selectable cards and may perform an item-selection process.

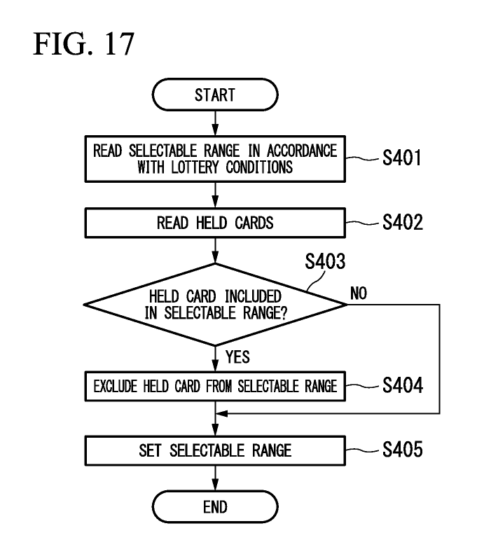

FIG. 17 is a flowchart that shows an example of the operation of processing for re-setting a card already granted to a player as a non-selectable card. This FIG. 17 shows the processing that excludes a card from a selectable range if, after re-setting the selectable range as described using FIG. 10 to FIG. 16 in the selectable range setting processing of the step S105 of FIG. 9, a card that has already been granted to the player is included in the selectable range.

The setting unit 344 reads from the item-selection conditions storage unit 324 information that indicates the selectable range in accordance with item-selection conditions (step S401). The setting unit 344 reads from the game item information storage unit 323 a card that a player holds, that is, a card that has already been granted to the player (step S402). The setting unit 344 makes a judgment regarding whether or not a card that is held by the player is included in the cards (selectable cards) in the selectable range read from the item-selection conditions storage unit 324 (step S403).

If the setting unit 344 makes the judgment that a card that the player holds is included in the selectable range cards (selectable cards) (YES at step S403), the held card is excluded from the selectable range cards (step S404). That is, the setting unit 344 sets the held card from being a selectable card to being a non-selectable card.

The setting unit 344 sets the card held by the player that was excluded from the selectable range cards (selectable cards) as a selectable range card (selectable card) and ends processing (step S405). If, however, the judgment is made by the setting unit 344 that the card held by the player is not included in the selectable range cards (selectable cards) (NO at step S403), processing proceeds to step S405, and the selectable range card (selectable card) that has been read from the item-selection condition storage unit 324 is set as a selectable range card (selectable card) and the selectable range setting processing (processing of step S105 shown in FIG. 9) is ended. The processing of step S106 and thereafter shown in FIG. 9 is executed.

In this manner, the setting unit 344 re-sets the selectable range so that cards already granted to a player are not made selectable range cards (selectable cards). By doing this, because the game device 300 does not grant once again a card that has already been gotten, when the selection unit 341 upon a request by a player to perform an item-selection process aiming at getting all the advantage cards, it is possible to provide the player with selection results that are free from stress.

As described above, even if cards are granted to a player by an item-selection process, the game device 300 can grant cards so that the player can continue to enjoy the game.

Although in the present embodiment the game items that are drawn by the selection unit 341 are indicated as cards that are used in a battle during progress through the game, this is not a restriction and, this may be applied to other items that are used within the game. That is, even if items are granted to a player by an item-selection process, the game device 300 can grant items so that the player can continue to enjoy the game.

Although the present embodiment has been described as the example in which the setting unit 344 sets each of the advantage cards to wither a selectable card (first game item) or non-selectable card that is not the target of selection (second game item), this is not a restriction. For example, the above-described non-selectable card (second game item, a card with an item-selecting probability of 0%) may be made a selectable card, but one that has a low item-selecting probability relative to a first game item, that is, a card that has a lower item-selecting probability than a first game item, but that is not an item-selecting probability of 0%. The setting unit 344 may set each of the advantage cards to be either a card (first game item) having an item-selecting probability of 30% or a card (second game item) having an item-selecting probability of 5%. Then, if a predetermined or preselected condition is satisfied, the setting unit 344 may re-set at least a part of the cards having an item-selecting probability of 5% (second game items) to become cards having an item-selecting probability of 30% (first game items).

The item-selecting probability allocated to each game item such as each card may be different among different game items or different cards, or identical to among some but not all of the game items or different cards, or identical to all game items or different cards.

The item-selection process or the card-selection process may be performed by, but not limited to, the following different ways.

In one item-selection way, each game item has been allocated with its own item-selecting probability by the setting unit 344, and the item-selection can be performed by the selection unit 341 using a random number that has been decided in random. It is not possible that no item can be selected or two or more items can be selected in the one item-selection process. For example, by the setting unit 344, the first, second and third game items such as cards are allocated with item-selecting probabilities of 10%, 30% and 60%, respectively. In each item-selection process, the selection unit 341 may decide a random number in random from a predetermined range, for example, of 1-100, and select any one of the first, second and third game items based on the decided random number. If the decided random number is in the range of 1-10, then the first game item is selected by the selection unit 341. If the decided random number is in the range of 11-40, then the second game item is selected by the selection unit 341. If the decided random number is in the range of 41-100, then the third game item is selected by the selection unit 341. Any one of the first, second or third items must be selected in each item-selection process.

In other item-selection way, for each game item, one item-selection process can be performed by the selection unit 341 to decide whether the each game item is selected or not. The plurality of item-selection processes can be performed by the selection unit 341 for the plurality of game items. It is possible that no item can be selected or two or more items can be selected as a result of the set of plural item-selection processes. For example, by the setting unit 344, the first, second and third game items such as cards are allocated with item-selecting probabilities of 10%, 30% and 60%, respectively. The selection unit 341 performs a set of the first, second and third item-selection processes. The first item-selection process is performed by the selection unit 341 based on the decided item-selecting probability of 10% for the purpose of deciding whether or not to select the first game item. In the first item-selection process, no decision is made on whether or not to select the second and third items. The second item-selection process is performed by the selection unit 341 based on the decided item-selecting probability of 30% for the purpose of deciding whether or not to select the second game item. In the second item-selection process, no decision is made on whether or not to select the first and third items. The third item-selection process is performed by the selection unit 341 based on the decided item-selecting probability of 60% for the purpose of deciding whether or not to select the third game item. In the third item-selection process, no decision is made on whether or not to select the first and second items. None of the first, second and third items or one or two of them or all of them can be selected in the set of the first, second and third item-selection processes. The order of performing the first, second and third item-selection processes may be optional.

Although, in the present embodiment, although the game system 1 has the configuration that is shown in FIG. 1, the configuration that has the user terminal 100, the SNS server 200, and the game device 300 may have an arbitrarily disposition, in accordance with a cloud environment, a network environment, the scale in terms of number of players, and the number and specification or the like of hardware devices prepared for the purpose of constituting the game system 1. For example, the various functions of the game device 300 may be constituted by distribution among a plurality of computers.

Also, the functions of each of the parts of the user terminal 100 may be implemented by downloading from another apparatus a program for the purpose of implementing the functions of each of those parts, and the functions may be implemented by a program of another apparatus. Without having the game application installed in the user terminal 100, if the user terminal 100 at least has the function of controlling reception and display of the game status, the progress of which is under the control of the game device 300, and the function of controlling reception of instruction information to the game and notification thereof to the game device 300, the other functions may be implemented at the game device 300 side.

Also, the user terminal 100 may be constituted to include a part of or all of the various parts provided by the game control unit 340 including the selection unit 341, the game item granting unit 342, the advantage granting unit 343, the setting unit 344, and the elapsed time detection unit 345, or a part of or all of the various parts provided by the server storage unit 320 including the game program storage unit 321, the player information storage unit 322, the game item information storage unit 323, and the item-selection conditions storage unit 324. Although the present embodiment is an example in which the game device 300 is configured as a computer (server), which provides a game to the user terminal 100, for example, the user terminal 100 may have a part of or all of the constituent parts of the game device 300, so as to execute a game in the user terminal 100.

Each part of the game control unit 340 may be implemented by dedicated hardware, or alternatively each part of the game control unit 340 may be constituted by a memory and a CPU (central processing unit), the functions of each part of the game control unit 340 being implemented by loading of a program for implementing the functions thereof into memory and executing the program so as to implement the functions thereof.

Also, the program for implementing the functions of each part of the game control unit 340 in the present embodiment may be recorded in a computer-readable recording medium and a computer system may be caused to read and execute the program stored in the recording medium so as to perform game control. The term “computer system” as used herein includes, but is not necessarily limited to, an operating system and hardware such as peripheral devices. Also, the computer system includes, but is not necessary limited to, a WWW system having a website-providing (or website display) environment.

The term “game” used herein may include any types of game that are playable on any available computer. In some cases, the game can be playable as, but not limited to, a way of connection among users.

The computer system may include a function of providing information in the format of a webpage coded in a mark-up language and a function of displaying that information with a browser.

As used herein, the system, device or unit as well as any other similar terms can be implemented by single computing or distributed computing, and each term is used to describe a component, section or part of hardware and/or software that is constructed and/or programmed to carry out the specified function. For example, the system can be implemented by operations of computers co-operable with each other and accessible to any available network.

The embodiments of methods, software, firmware or codes described above may be implemented by instructions or codes stored on a machine-accessible or machine readable medium. The instructions or codes are executable by a processing element or processing unit. The machine-accessible/readable medium may include, but is not limited to, any mechanisms that provide, store and/or transmit information in a form readable by a machine, such as a computer or electronic system. In some cases, the machine-accessible/readable medium may include, but is not limited to, random-access memories (RAMs), such as static RAM (SRAM) or dynamic RAM (DRAM), read-only memory (ROM), magnetic or optical storage medium and flash memory devices. In other cases, the machine-accessible/readable medium may include, but is not limited to, any mechanism that receives, copies, stores, transmits, or otherwise manipulates electrical, optical, acoustical or other form of propagated signals such as carrier waves, infrared signals, digital signals, including the embodiments of methods, software, firmware or code set forth above.

Furthermore, the particular features, structures, or characteristics may be combined in any suitable manner in one or more embodiments.

It is apparent that the present invention is not limited to the above embodiments, but may be modified and changed without departing from the scope and spirit of the invention.

What is claimed is:

1. A game system comprising:
a setting unit configured to allocate each game item of a plurality of game items with its own item-selecting probability;
a selection unit configured to perform an item selection process in accordance with the item-selecting probabilities that are respectively allocated to the plurality of game items;
a game item granting unit configured to grant at least one of plurality of game items to game player in accordance with a result of at least one of the item-selection processes performed by the selection unit; and
an advantage granting unit configured to grant at least an advantage to game player, if the game item granting unit has granted, to game player, at least one predetermined game item that is included in the plurality of game items,
wherein the setting unit is configured to re-allocate a higher item-selecting probability to at least one game item that has been allocated with a lower item-selecting probability than the higher item-selecting probability, if the setting unit recognizes that a predetermined condition is satisfied.

2. The game system according to claim 1, wherein the setting unit is configured to re-allocate the higher item-selecting probability to at least one game item of the non-highest item-selecting probability once allocated and lower than the highest item-selecting probability, if the setting unit recognizes that the predetermined condition is satisfied.

3. The game system according to claim 1, wherein the predetermined condition comprises a condition related to the status of progress through the game.

4. The game system according to claim 1, wherein the predetermined condition comprises a condition related to the status of granting game player the game items having the higher item-selecting probability.

5. The game system according to claim 1, wherein the predetermined condition comprises a condition indicating that all of the game items having the higher item-selecting probability have been granted to game player.

6. The game system according to claim 1, wherein the predetermined condition comprises a condition related to an elapsed time elapsed after the start of a predetermined period of time.

7. The game system according to claim 1, wherein the predetermined condition comprises a condition related to an elapsed time after the start of the item-selection process by the selection unit.

8. The game system according to claim 6, further comprising:
an elapsed time detection unit configured to detect the elapsed time,
wherein the setting unit is configured to re-allocate a higher item-selecting probability to at least one game item having a lower item-selecting probability than the higher item-selecting probability, if the setting unit recognizes that the predetermined condition is satisfied by determining that the elapsed time detected by the elapsed time detection unit is equal to or greater than a predetermined threshold value.

9. The game system according to claim 8, wherein the setting unit is configured to re-allocate a higher item-selecting probability to at least one game item having a lower item-selecting probability than the higher item-selecting probability, if the setting unit recognizes that the predetermined condition is satisfied by determining that the elapsed time detected by the elapsed time detection unit is equal to or greater than a predetermined threshold value, the determination is made by the setting unit with reference to a re-setting schedule, the re-setting schedule associates the predetermined threshold value to the game items to be re-allocated with the higher item-selecting probability.

10. The game system according to claim 1, wherein the predetermined conditions comprises a condition related to the number of times that the selection unit has performed the one more item-selection processes.

11. The game system according to claim 1, wherein the game item granting unit is configured to associate game player with the game item that has been granted to game player, and the selection unit is configured to perform an item-selection process of selecting, in accordance with a request by game player, game items of the plurality of game items other than the game items associated with game player.

12. A method of controlling a game system, the method comprising:
allocating each game item of a plurality of game items with its own item-selecting probability;
conducting an item-selection process in accordance with the item-selecting probabilities that are respectively allocated to the plurality of game items;
granting at least one of the plurality of game items to game player in accordance with a result of at least one of the item-selection processes as performed;
granting at least an advantage to game player, if game player has been granted with at least one predetermined game item that is included in the plurality of game items; and
re-allocating a higher item-selecting probability to at least one game item that has been allocated with a lower item-selecting probability than the higher item-selecting probability, if a predetermined condition is satisfied.

13. A non-transitory computer-readable storage medium storing a program to be executed to perform a method of controlling a game system, the method comprising:
allocating each game item of a plurality of game items with its own item-selecting probability;
conducting an item-selection process in accordance with the item-selecting probabilities that are respectively allocated to the plurality of game items;
granting at least one of the plurality of game items to game player in accordance with a result of at least one of the item-selection processes as performed;
granting at least an advantage to game player, if game player has been granted with at least one predetermined game item that is included in the plurality of game items; and
re-allocating a higher item-selecting probability to at least one game item that has been allocated with a lower item-selecting probability than the higher item-selecting probability, if a predetermined condition is satisfied.
